(19) United States
(12) Patent Application Publication
(10) Pub. No.: US 2019/0255741 A1
(43) Pub. Date: Aug. 22, 2019

(54) Ventilation Unit for a Vulcanization Mold of a Vehicle Pneumatic Tire

(71) Applicant: Continental Reifen Deutschland GmbH, Hannover (DE)

(72) Inventors: Magnus Hasselloef, Hemmingen (DE); Juergen Dzick, Seelze (DE)

(21) Appl. No.: 16/307,913

(22) PCT Filed: May 8, 2017
(86) PCT No.: PCT/EP2017/060854

§ 371 Date: Dec. 6, 2018

(30) Foreign Application Priority Data
Jun. 6, 2016 (DE) 10 2016 209 912.4

(51) Int. Cl. B29C 33/10; B29D 30/06

(52) U.S. Cl. CPC B29C 33/10; B29D 2030/0617; B29D 30/0606

(57) ABSTRACT

Venting unit for a vulcanizing mold of a pneumatic vehicle tire, having a cylindrical housing, which can be pressed into a venting bore of the vulcanizing mold, and a valve insert, which is positioned in the housing and is movable relative thereto and has a valve shank with a valve disk and has a helical compression spring, which surrounds the valve shank and is supported with its one end on the housing and with its other end on the valve disk, the valve shank having a base portion with an outer diameter (d₆) which is greater than the inner diameter of the helical compression spring. The valve disk is adjoined by a cylindrical holding portion, onto which the helical compression spring can be firmly fitted, the holding portion having a greater diameter than the base portion, the helical compression spring having at least two closely spaced turns at least at its end that can be fitted onto the holding portion.

### CROSS REFERENCE TO RELATED APPLICATIONS

This application is the national stage of PCT/EP 2017/060854, filed May 8, 2017, designating the United States and claiming priority from German patent application no. 10 2016 209 912.4, filed Jun. 6, 2016, the entire contents of which are incorporated herein by reference.

### FIELD OF THE INVENTION

The invention relates to a venting unit for a vulcanizing mold of a pneumatic vehicle tire, having a central longitudinal mid-axis, a cylindrical housing, which can be pressed into a venting bore of the vulcanizing mold, and a valve insert, which is positioned in the housing and is movable relative thereto and has a valve shank with a valve disk and has a helical compression spring, which surrounds the valve shank and is supported with its one end on the housing and with its other end on the valve disk, the valve shank having a base portion with an outer diameter which is greater, by at least 0.3 mm, than the inner diameter of the helical compression spring.

### BACKGROUND OF THE INVENTION

It is known and customary that in vulcanizing molds for pneumatic vehicle tires, in particular for passenger cars, there are on average approximately 4500 venting bores, with the same number of venting units inserted in them. The venting units contain valve inserts, the valve disks of which close the venting bores on the molded green tire and at least largely prevent the occurrence of rubber flash during the vulcanization of the tire. During the molding of the green tire, the valve inserts are open and the valves disks protrude on the inner side of the mold, so that the required venting can take place during the molding of the green tire. A venting unit of the type mentioned at the beginning is known for example from EP 0 774 333 B1. In that portion onto which the helical compression spring has been pushed, the valve shank of this known venting unit has a constant diameter in such a way that the helical compression spring is positioned relatively loosely around the valve shank. Only directly at the valve disk is a very narrow shank portion of a greater diameter provided, on which not even the complete end turn of the helical compression spring can be fitted, in this region supporting itself on the inner side of the valve disk. An exact positioning of the helical compression spring is consequently difficult, and causes unnecessary time to be expended when assembling the venting unit. Helical compression springs that are positioned inadequately or not exactly also adversely affect the functional capability of the complete venting unit, and are usually responsible for the valve disks not closing well or tipping during the molding of the green tire. In addition, automatic positioning of the valve shanks together with the helical compression springs in the housing is not possible.

### SUMMARY OF THE INVENTION

It is an object of the invention to improve a venting unit of the type mentioned at beginning in this respect, in particular in order to ensure exact and optimum seating of the helical compression spring, which is primarily responsible for satisfactory functioning of the venting unit. Furthermore, automatic positioning of the valve shanks in the housing is also to be made possible.

This object is achieved according to the invention by the valve disk being adjoined by a cylindrical holding portion, onto which the helical compression spring can be firmly fitted, the holding portion having a greater diameter than the base portion and a height of at least 1.0 mm, the helical compression spring having at least two closely spaced turns at least at its end that can be fitted onto the holding portion.

The configuration of the valve shank in the way according to the invention, with a holding portion, allows the helical compression spring to be captively secured by at least two of its turns on the holding portion, but to be fully functional, centered and consequently positioned in the desired position. The invention also allows springs of different spring strengths to be positioned in this way. Since the problems described above are overcome by the invention, with an exact and centered mounting of the helical compression spring on the valve shank, the valve shank together with the helical compression spring can be positioned in the housing in an automated manner, with no risk of undesired deformation of the spring. With automatic insertion of the valve shank, it is for example fired into the housing by means of compressed air. In order for this to happen satisfactorily, the helical compression spring must be firmly clamped on, in order that during the insertion of the valve shank it does not project beyond the valve shank at the front and cannot be caught.

In the case of a preferred embodiment of the invention, the closely spaced turns of the helical compression spring have a mutual spacing which, in the relaxed state of the helical compression spring, corresponds to at most half, in particular at most a third, of the mutual spacing of the other turns.

In order to ensure film clamping of the closely spaced turns of the helical compression spring on the cylindrical holding portion, it is of advantage if the cylindrical holding portion has a height of up to 1.5 mm.

According to a further preferred embodiment of the invention, between the base portion and the holding portion there is a centering portion, which is a sloping surface that runs around the valve shank and preferably runs at an angle of 10° to 20°, in particular of 15°, in relation to the central longitudinal mid-axis. The central portion consequently assists and facilitates the fitting of the helical compression spring onto the holding portion.

### BRIEF DESCRIPTION OF THE DRAWINGS

The invention will now be described with reference to the drawings wherein:

FIGS. 1A and 1B schematically show sectional representations of a partial region of a mold segment of a vulcanizing mold,

FIG. 2 shows a longitudinal section of a variant of the embodiment of a venting unit embodied according to the invention.

FIG. 3A and FIG. 4 show sectional representations of individual component parts of the venting unit according to FIG. 2, FIG. 3B shows a variant of FIG. 3A; and,

FIG. 5 and FIG. 6 show variants of the embodiment of the configuration of a valve disk.

### DESCRIPTION OF THE PREFERRED EMBODIMENTS OF THE INVENTION

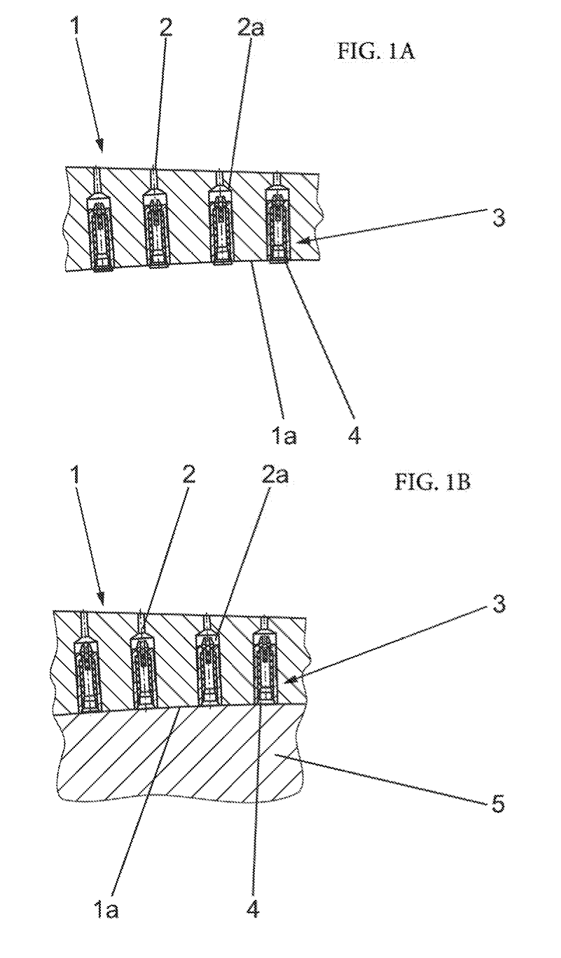

FIGS. 1A and 1B show sectional representations of part of a mold segment 1 of a vulcanizing mold which is radially divided in the usual way by the part forming the tread region into a number of mold segments, in particular between seven and thirteen mold segments being provided. The sections through the mold segment 1 also show a number of longitudinal sections through venting bores 2, which are oriented in the radial direction and, in the case of the embodiment shown, respectively have on the mold segment inner side 1a a portion 2a with a greater diameter. In each portion 2a, a venting unit 3 is inserted. In the representation shown in FIG. 1A—without the molded green tire—the venting units 3 are all open, spring-loaded valve disks 4 projecting slightly beyond the mold segment inner side 1a and protruding into the vulcanizing mold cavity. In a manner of representation analogous to FIG. 1A, FIG. 1B shows the moment where, toward the end of the molding of a green tire, a part thereof that is forming the tread 5 has come into contact with the mold segment inner side 1a, so that the raw tread 5 has pressed the valve disks 4 into the closed position that is shown in FIG. 1B.

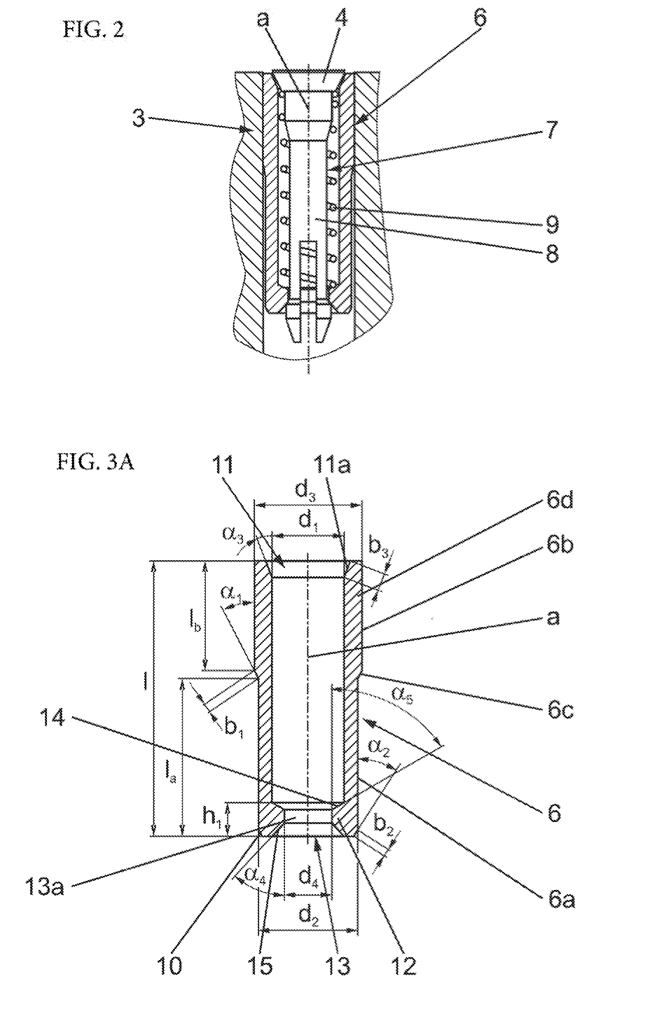

FIG. 2 shows in the same sectional plane as FIGS. 1A and 1B, in an enlarged representation, an individual venting unit 3, which a housing 6, a valve insert 7 comprising a valve shank 8 and the already mentioned valve disk 4 and also a helical compression spring 9, which surrounds the valve shank 8 and is supported with its one end on the housing 6 and with its other end on the underside of the valve disk 4. The venting unit 3 has a longitudinal mid-axis a, which runs in its longitudinal extent—in mold segments that form the tread this corresponds to the radial direction in the tire—with respect to which most of the component parts of the venting unit 3 are embodied rotationally symmetrically. The longitudinal mid-axis a of the venting unit 3 is therefore at the same time the longitudinal mid-axis a of the housing 6 and of the valve insert 7.

In the following detailed description of individual component parts of the venting unit 3, the configuration of these component parts is considered with reference to their installation position in the mold segment 1 or the position in the figures; this concerns for example designations such as outer or upper and inner. The venting unit represented is, by way of example, a venting unit with a diameter of 3.2 mm, therefore a venting unit for vulcanizing molds for car tires. Usually, venting units can have a diameter (diameter adapted to the venting bore) of 2 mm to 5 mm.

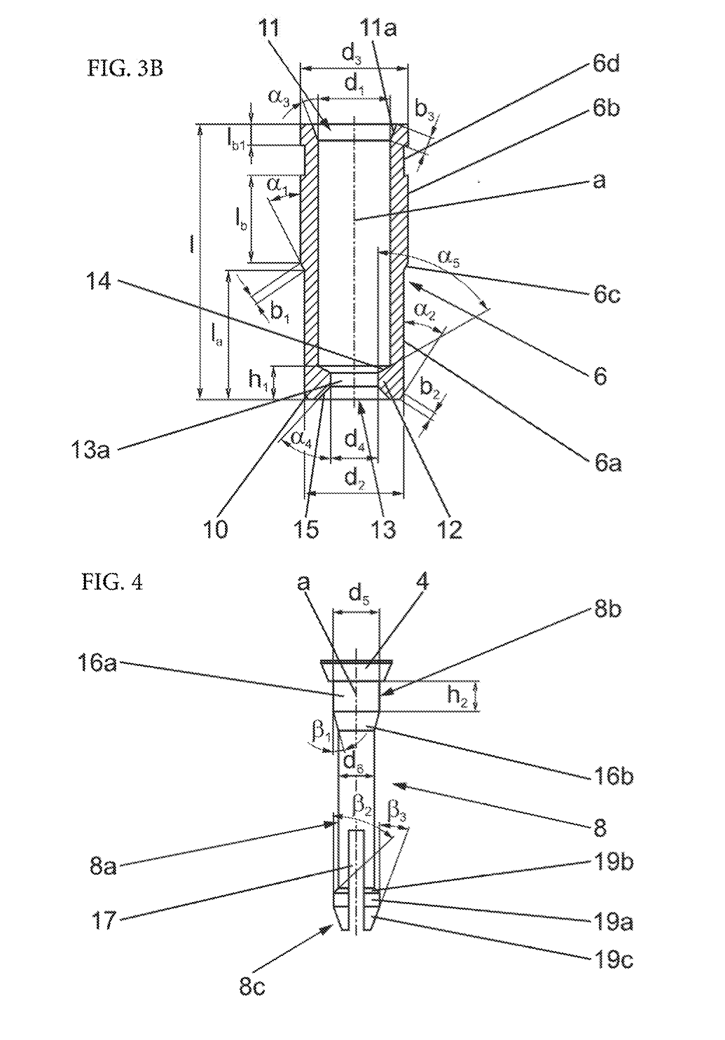

The housing 6 that is shown separately in FIGS. 3A and 3B is substantially a cylindrical sleeve with a constant inner diameter d₁ over most of its extent along the longitudinal mid-axis a. The housing 6 has on its outer side an inner portion 6a, which reaches up to the inner-side end of the housing 6 and has a length lₐ, which is at least 35% of the housing length l. The portion 6a has an outer diameter d₂, which is smaller by at least 0.3 mm, in particular by up to 0.5 mm, than the inner diameter of the bore portion 2a. In the case of both variants of the embodiment, the inner portion 6a transitions into a further portion 6b via a sloping surface 6c running around the housing 6. In the case of the embodiment shown in FIG. 3A, the further portion 6b extends up to the outer or upper end of the housing 6. In the case of the embodiment shown in FIG. 3B, the upper end of the housing 6 is adjoined by a narrow peripheral portion 6b₁, which is separated from the portion 6b by a narrow portion 6d that runs around the housing 6 and is configured in cross section in the manner of a groove, the outer diameter of the portion 6d corresponding in particular to the outer diameter d₂ of the inner portion 6a. The peripheral portion 6b₁ has a length lb₁ of at least 1.0 mm. Both the portion 6b (FIG. 3A, FIG. 3B) and the peripheral portion 6b₁ (FIG. 3B) have an outer diameter d₃, which is greater by 0.3 mm to 0.5 mm than the outer diameter of the portion 6a and is adapted to the inner diameter of the portion 2a of the venting bore 2 in such a way that the portion 6b (FIG. 3A) or the latter and the peripheral portion 6b1 (FIG. 3B) can be pressed into the venting bore 2. The portion 6b or the portions 6b and 6b1 extends or extend altogether over a length l_{b} (FIG. 3A) or l_{b}+lb₁ (FIG. 3B) of 30% to 45 of the housing length l. The housing 6 may furthermore have more than two portions, the outer diameter of which is adapted in the way mentioned to the inner diameter of the venting bore 2. The sloping surface 6c running around the outside of the housing 6, between the inner portion 6a and the adjoining portion 6b, runs at an angle α₁ of 10° to 60°, in particular of 15° to 45°, in relation to the outer side of the portion 6b or in relation to the longitudinal mid-axis a. The width b₁ of the sloping surface 6c is for example of the order of magnitude of 0.20 to 0.30 mm.

A further sloping surface 10 with an inward inclination is formed on the outside at the inner end of the housing 6. The sloping surface 10 is a kind of bevel on the edge of the housing and runs at a constant angle α₂, which is 10° to 60°, in particular 15° to 45°, in relation to the outer side of the portion 6a or in relation to the longitudinal mid-axis a. The sloping surface 10 is very narrow; its width b₂ is of the order of magnitude of 0.15 to 0.20 mm.

On the outer end region, facing the mold segment inner side 1a, the housing 6 is provided on the inside with a widening 11 in the form of a truncated cone, which is adapted to the configuration of the valve disk 4, which, as for example FIG. 2 shows, is likewise configured in the form of a truncated cone. The widening 11 is accordingly formed by a sloping surface 11a, which runs around the inside on the periphery of the housing 6 and runs at an angle α₃ of 10° to 45°, preferably 15° to 30°, in particular 22°, in relation to the longitudinal mid-axis a. The width b₃ of the sloping surface 11a is of the order of magnitude of 0.5 mm.

On the end region of the housing 6 that is opposite from the widening 11 in the form of a truncated cone there is a housing base 12, which has a middle circular opening 13 with a central narrowest opening portion 13a, the inner diameter d₄ of which is smaller than the inner diameter d₁ of the housing 6 and is surrounded by a narrow ring. Above and below the opening portion 13a, the opening 13 is widened by means of a respective sloping surface 14, 15. The sloping surface 15 running on the outside of the housing base 12 runs at an angle of α₄ of 30° to 60°, in particular of approximately 45°, in relation to the longitudinal mid-axis a. On the inside of the housing, the second sloping surface 14 in the case of the embodiment shown forms a transitional surface with respect to the housing inner wall and runs at an angle α₅ of 30° to 70°, in particular of the order of magnitude of 60°, in relation to the longitudinal mid-axis a. The height h₁ of the housing base 12 parallel to the longitudinal mid-axis a is of the order of magnitude of 0.4 mm to 0.6 mm.

The valve insert 7 is now described in more detail on the basis of FIGS. 2 and 4. FIG. 4 shows the valve shank 8, which is made up of a cylindrical base portion 8 a of a constant diameter, running over the majority of its extent, an end portion 8b, which is facing the mold segment inner side 1a and on which the valve disk 4 is located, and an end portion 8c, which is facing away from the mold segment inner side. The end portion 8b has a cylindrical holding portion 16a, which adjoins the valve disk 4 and has a height h₂ of 1.0 mm to 1.5 mm and the diameter d₅ of which is greater than the diameter d₆ of the base portion 8a and is adapted to the inner diameter of the helical compression spring 9 in such a way that the latter can be firmly fitted onto the holding portion 16a and support itself on the inside of the valve disk 4. As FIG. 2 shows, the helical compression spring 9 has at its end that can be fitted onto the holding portion 16a at least two narrowly spaced turns 9a, the mutual spacing of which in the relaxed state of the helical compression spring 9 corresponds to at most half, in particular at most a third, of the mutual spacing of the other turns. Such a “double turn” may also be provided at the second end of the helical compression spring 9. The diameter d₆ of the base portion 8a is adapted to the inner diameter d₄ of the opening portion 13a in the housing base 12. The diameter d₆ of the base portion 8a is smaller by at least 0.3 mm than the inner diameter of the helical compression spring 9. Between the base portion 8a and holding portion 16a there is a centering portion 16b, which is a sloping surface running around the end portion 8b and runs at an angle β₁ of 10° to 20°, in particular of the order of magnitude of 15°, in relation to the central longitudinal mid-axis a.

The second end portion 8c is divided into two in the middle by a slit 17 extending along the longitudinal mid-axis a and reaching into the base portion 8a. The slit 17 allows the two end portion parts 18a, 18b to be pressed together and moved apart, so that the valve shank 8 can be led through the constriction or the opening 13 in the peripheral projection 12 of the housing 6 and can in this way be fastened on the housing 6. Each end portion part 18a, 18b forms a projection, which according to the cylindrical form of the shank is in each case rounded overall. At its widest point, each projection has a collar 19a, which adjoins the base portion 8a via a sloping surface 19b. The sloping surfaces 19b run at an angle 132 of 30° to 60°, in particular of 45°, in relation to the longitudinal mid-axis a, the angle β₂ preferably corresponding to the angle α₄ of the sloping surface 15 at the opening 13 in the housing base 12 of the housing 6, so that, as FIG. 2 shows, with the valve shank 8 inserted the sloping surface 19b supports itself on the sloping surface 15 of the housing 6. The end portion parts 18a, 18b taper in the direction of the end of the shank and have on the outer side sloping surfaces 19c, which respectively run at an angle β₃ of 15° to 25°, in particular of 20°, in relation to the longitudinal mid-axis a and form an insertion aid during the insertion of the valve shank 8 into the housing 6. As FIG. 2 shows, with the valve shank 8 inserted in the housing 6, the end portions 18a, 18b are below the opening 13.

To assemble the venting unit 3, the helical compression spring 9 is positioned over the valve shank 8 and the valve shank 8 is led through the middle opening 13 in the projection 12 of the housing while pressing together the two end portion parts 18a, 18b and in this way is fastened on the housing 6. The sloping surfaces 14 above the opening portion 13a and the sloping surfaces 19c on the valve shank 8 make insertion possible with little expenditure of force.

In the case of the embodiment shown in FIG. 2 and FIG. 4, the valve disk 4 is configured with a planar outer surface. However, at least one elevation and at least one depression may be formed on the surface of the valve disk, any surface region outside the elevation or depression remaining planar. The height of the elevation or elevations, in the vertical direction with respect to a plane containing the circular periphery of the valve disk, should preferably correspond to at most the lift of the valve shank 8. Elevations and depressions may be of almost any desired configuration, the depression(s) or elevation(s) preferably being arranged or formed symmetrically with respect to at least one plane that contains the central longitudinal mid-axis a. Elevations or depressions may be configured in the form of a cuboid, in plan view in the form of a star or in the form of a circle and the like. Elevations have either a rounded surface or an outer surface that runs parallel to the plane containing the circular periphery of the valve disk.

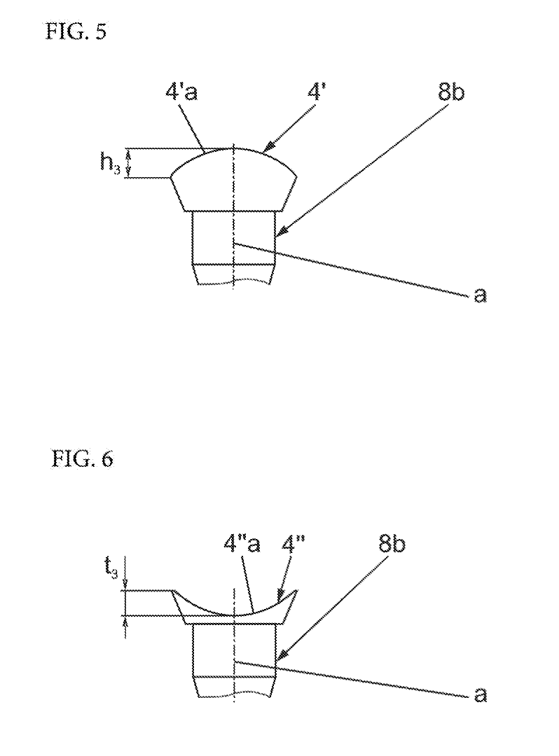

FIG. 5 and FIG. 6 show preferred variants of the embodiment of valve disks 4′, 4″ on the basis of a partial region of the end portion 8a of the valve shank 8. The valve disk 4′ according to FIG. 5 has as an elevation an outward curvature of the entire surface 4′a of the valve disk 4′; the valve disk 4″ according to FIG. 6 has as a depression an inward curvature of the entire surface 4″a. The curvatures may take the form of portions of a sphere, the height h₃ or depth t₁ of the portion of the sphere, with respect to the plane containing the circular periphery of the valve disk, corresponding to at most 30% of the radius of the sphere on which it is based and being at most 0.50 mm.

On the one hand, an elevation or a number of elevations on the valve disk can have the effect of assisting the movement of the valve disk into its closed position; on the other hand, elevations and/or depressions on the valve disk can have the effect that local depressions or elevations, which are perceived as being visually less disturbing than the impressions of valve disks with a flat surface, are specifically formed on the tread of the tire.

The venting unit 3 can be inserted in a precise and easy way into the portion 2a of the venting bore 2 of the mold segment 1. Since only the outer portion 6a of the housing 6 is pressed into the venting bore 2, the housing 6 is positioned with its thinner portion 6b in the venting bore 2. The sloping surface 10 at the lower end of the portion 6b assists easy insertion into the bore 2. As a result, it is possible also to insert the housing 6 by machine without having a perfect alignment of the device, for example a robot, in relation to the bore. The longer thinner portion 6b has the effect that the housing 6 is pre-adjusted in the bore 2 and is substantially parallel to the axis of the bore when the sloping surface 6c comes into contact with the periphery of the bore. Then the housing 6 is exactly centered and aligned straight, in order that the housing 6 is then introduced parallel to the axis of the bore, without damaging or asymmetrically widening the periphery of the bore. Therefore, not only is a particularly exact positioning of the venting unit 3 in the venting bore 2 made possible, but the expenditure of force is also reduced significantly. In principle, the venting unit 3 may be completely assembled from its parts before it is introduced into the venting bore. However, it is also possible first to introduce the housing 6 into the venting bore 2 and then to position the further parts in the housing 6.

It is understood that the foregoing description is that of the preferred embodiments of the invention and that various changes and modifications may be made thereto without departing from the spirit and scope of the invention as defined in the appended claims.

### LIST OF REFERENCE NUMERALS

1 . . . Mold segment
1a . . . Mold segment inner side
2 . . . Venting bore
2a . . . Portion
3 . . . Venting unit
4, 4′, 4″ . . . Valve disk
5 . . . Tread
6 . . . Housing
6b₁ . . . Peripheral portion
6a, 6b . . . Portion
6c . . . Sloping surface
6d . . . Portion
7 . . . Valve insert
8 . . . Valve shank
8a . . . Base portion
8b, 8c . . . End portion
9 . . . Helical compression spring
9a . . . Turn
10 . . . Sloping surface
11 . . . Widening
11a . . . Sloping surface
12 . . . Housing base
13 . . . Opening
13a . . . Opening portion
14, 15 . . . Sloping surface
16a . . . Holding portion
16b . . . Centering portion
17 . . . Slit
18a, 18b . . . End portion part
19a . . . Collar
19b, 19c . . . Sloping surface
a . . . Longitudinal mid-axis
b₁, b₂, b₃ . . . Width
d₁, d₂, d₃, d₄, d₅, d₆ . . . Diameter
l . . . Housing length
lₐ, l_{b}, l_{b1} . . . Length
α₁, α₂, α₃, α₄, α₅ . . . Angle (housing)
β₁, β₂, β₃ . . . Angle (shank)
h₁, h₂, h₃ . . . Height
t₁ . . . Depth

1-5. (canceled)

6. A venting unit for a vulcanizing mold of a pneumatic vehicle tire, the venting unit defining a central longitudinal mid-axis and comprising:
a cylindrical housing pressable into a venting bore of the vulcanizing mold;
a valve insert positioned in said cylindrical housing and being movable relative thereto;
said valve insert having a valve shank with a valve disk;
a helical compression spring having an inner diameter and surrounding said valve shank and being supported with its one end on said cylindrical housing and with its other end on said valve disk;
said valve shank having a base portion with an outer diameter (d₆) which is greater by at least 0.3 mm than said inner diameter of said helical compression spring;
said valve disk being adjoined by a cylindrical holding portion onto which said helical compression spring is firmly fitted;
said cylindrical holding portion having a greater diameter than said base portion and a height (h₁) of at least 1.0 mm; and,
said helical compression spring having at least two closely spaced turns at least at its end that can be fitted onto said holding portion.

7. The venting unit of claim 6, wherein the closely spaced turns of said helical compression spring have a mutual spacing which, in the relaxed state of said helical compression spring, correspond to at most half, in particular at most a third, of the mutual spacing of the other turns.

8. The venting unit of claim 6, wherein said cylindrical holding portion has a height (h₁) of up to 1.5 mm.

9. The venting unit of claim 6, wherein, between said base portion and said holding portion, there is a centering portion which defines a sloping surface that extends around said valve shank.

10. The venting unit of claim 9, wherein said centering portion runs at an angle (β₁) of 10° to 20° in relation to the central longitudinal mid-axis.

11. The venting unit of claim 9, wherein said centering portion runs at an angle (β₁) of 15° in relation to the central longitudinal mid-axis.
